(19) United States
(12) Patent Application Publication
(10) Pub. No.: US 2012/0064255 A1
(43) Pub. Date: Mar. 15, 2012

(54) VIBRATION DAMPING COATING

(75) Inventors: Robert W. Willson, Kettering, OH (US); Michael C. Willson, Troy, OH (US); John P. Henderson, Beavercreek, OH (US)

(73) Assignee: APS MATERIALS, INC., Dayton, OH (US)

(21) Appl. No.: 12/878,167

(22) Filed: Sep. 9, 2010

(51) Int. Cl. C23C 4/04; C03C 8/20; C03C 8/14

(52) U.S. Cl. 427/452; 501/17; 501/18

(57) ABSTRACT

A method is disclosed for applying a vibration-damping surface to an article. The method includes providing a coating material comprising a ceramic, metallic or cermet material and a viscoelastic glass frit and plasma spraying the coating material onto an article. The coating material forms a plurality of ceramic, metallic or cermet microstructures having voids with the viscoelastic glass frit distributed to interact with the voids to provide vibration damping. Also disclosed are plasma spray coatings for damping vibrations that includes a ceramic-glass frit composite coating capable of reducing resonant vibrations in a substrate at temperatures between 700° F. to 1500° F. and said plasma spray coating as a coating on a substrate.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of contract No. W911W6-07-C-0043 awarded by Aviation Applied Technology Directorate, US Army Research, Development and Engineering Command.

### TECHNICAL FIELD

The present invention relates generally to vibration damping coatings and, more particularly, to vibration damping coatings for high temperatures such as those experienced in a turbine engine.

### BACKGROUND

Vibration-induced high cycle fatigue (HCF) failures of static and rotating components exist in turbine engines and are a concern for the operation and life of the engine. These HCF failures are generally due to high vibratory stresses due to the response of components at resonant frequencies. The vibratory response at resonant frequencies of a structure is limited by the damping in the system. Engine rotating components include one-piece integrally bladed rotors (IBRs), which are increasingly used in military engine compression system components. In general, IBRs are lighter weight and offer performance benefits over conventional bladed disk assemblies. However, the one-piece nature of the IBR results in low inherent structural damping and an increased susceptibility to HCF failures. Other engine static components include variable and non-variable compressor vanes which also experience HCF failures. In addition to military turbine engine components, HCF can occur in commercial aircraft turbine engines, ground-based power turbines, automotive turbochargers and many other types of structures operating in an environment that can induce high vibratory resonant stresses at elevated temperatures.

High velocity oxygen fuel (HVOF) thermal spray coatings have been tried as coatings to reduce the HCF failures, but have been unsuccessful, in particular at elevated temperatures similar to those experienced in turbine engines. The HVOF thermal spray process is basically the same as the combustion powder spray process (LVOF) except that this process has been developed to produce extremely high spray velocity. HVOF thermal spray coatings are produced by first mixing a fuel gas and oxygen within a chamber. The resulting mixture exits the chamber through the nozzle and ignites. The powder feedstock is then fed via carrier gas, axially, into the ignited gases and is propelled uniformly to the work piece. In using both kinetic and thermal energy, the molten particles impact the substrate producing a coating with characteristics fundamentally different than a coating from a Plasma Spray Coating Method. The HVOF process creates extremely dense coatings having a very predictable and homogeneous chemistry with bond strengths in excess of 10,000 PSI with very low surface roughness, which make the HVOF coatings less suitable for damping at the high temperatures experienced in turbine engines.

### SUMMARY

Disclosed are high temperature damping coatings for reducing the resonant vibration of turbine engine components or other high temperature structures that experience resonant frequencies at temperatures of at least about 700° F. The coatings are examples of a class of coatings which include plasma sprayed “hard” materials such as ceramic, metallic or cermet with small quantities of embedded glass, or porcelain enamel, material. In one embodiment, the glass or porcelain enamel is present as less than about 15% by weight, more preferably less than about 10% by weight. The plasma sprayed coatings consist of dense microstructures of the hard material which exhibit a complex structure with microvoids and microcracks having the glass or porcelain enamels distributed to interact with the microvoids and microcracks. In particular, in the elevated temperature range, the glass or porcelain enamel starts to soften and exhibits viscoelastic behavior which dissipates mechanical strain energy in the form of thermal energy resulting in damping of the resonant vibration of the coated structure.

For a given thickness of a damping coating, which in one embodiment may comprise a relatively thin bond coat with a relatively thicker top coat, the one measure of damping merit is Young's loss modulus. Factors that effect the Young's loss modulus include the glass or porcelain enamel used, the percent by weight of glass or porcelain enamel in the coating, the temperature, and the frequency of vibration.

In one aspect, a method of applying a vibration damping surface structure to an article is disclosed herein that includes: a) providing a coating material comprising a ceramic, metallic or cermet and a viscoelastic glass frit, and b) plasma spraying the coating material onto the article, wherein the coating material forms a plurality of ceramic, metallic or cermet microstructures with the viscoelastic glass frit distributed to interact with the microstructures to provide vibration damping to the coated article. The viscoelastic glass frit provides the vibration damping by converting vibrational energy in the article to thermal energy. In one embodiment, the microstructures are generally pancake-like lamellae and include voids such as microcracks, pores, regions of incomplete bonding, and combinations thereof. The method may also include the step of applying a bondcoat to the article. In one embodiment, the bondcoat is applied as a plasma spray coating.

In one embodiment, the coating material is a mixture of the ceramic, metallic or cermet and the viscoelastic glass frit, wherein each is provided as a powder. The mixture may include about 15% by weight or less of the viscoelastic glass frit. In one embodiment, the mixture includes about 10% by weight or less of the viscoelastic glass frit and, in another embodiment, includes about 5% by weight or less of the viscoelastic glass frit. The viscoelastic glass frit may have an initial softening point of at least about 700° F. In another embodiment, the viscoelastic glass frit may have an initial softening point of 900° F.

In one embodiment, the ceramic, metallic, or cermet includes zirconia such as a yttria-stabilized zirconia. The yttria-stabilized zirconia may be about a 3% to about 10% yttria-stabilized zirconia. In one embodiment, the zirconia is about a 5% to about 8% yttria-stabilized zirconia.

In one embodiment, the plasma sprayed coating material has a Young's loss modulus at 1000 Hertz of greater than 200 ksi between 800° F. and 1500° F. In another embodiment, the plasma sprayed coating material has a Young's loss modulus at 1000 Hertz of greater than 600 ksi or greater than 700 ksi or even greater than 1000 ksi between 800° F. and 1500° F.

In other embodiments, the glass frit is present in the coating as 10% by weight and the plasma spray coating material had a Young's loss modulus at 1000 Hertz of greater than 600 ksi between 950° F. and 1080° F., or greater than 700 ksi between 980° F. and 1280° F., or greater than 1000 ksi between 1110° F. and 1320° F. In one embodiment, where the Young's loss modulus is greater than 600 ksi between 950° F. and 1080° F., the viscoelastic glass frit includes 20-30% by weight Al, 50-60% by weight B, and 20-30% by weight Na or comprises 90-95% by weight Al, 1-5% by weight Ba, and 1-5% by weight Sb. In one embodiment, where the Young's loss modulus is greater than 1000 ksi between 1110° F. and 1320° F., the viscoelastic glass frit includes 22-27% by weight Al, 10-20% by weight Ba, 45-50% by weight B, 10-20% by weight F, and 15-20% by weight Na.

In another aspect, plasma spray coatings are disclosed for damping vibrations. The plasma spray coating includes a ceramic-glass frit composite coating capable of reducing resonant vibrations in a substrate at temperatures between 800° F. to 1500° F. The ceramic and glass frit components of the composite may be similar to those described above and the plasma spray coating may have any of the Young's loss moduli described herein. In one embodiment, the plasma spray coating is coating a surface of a substrate and may include a bondcoat between the substrate and the layer comprising the ceramic-glass frit composite.

### BRIEF DESCRIPTION OF THE DRAWING

FIG. 1 is an example of an airfoil having damped vibrational characteristics in accordance with one embodiment of a coating.

FIG. 2 is a cross-sectional view of the airfoil of FIG. 1 taken along line 2-2.

FIG. 3 is an exploded schematic of the coating within the circle in FIG. 2.

FIG. 4 is a SEM top view image of one embodiment of a vibration damping coating.

FIG. 5 is a SEM cross-sectional view of one embodiment of a vibration damping coating on a rotor blade substrate.

FIG. 6 is a graph showing the damping effect of a vibration damping coating having a viscoelastic glass frit and zirconia.

FIG. 7 is a graph showing the Young's loss moduli of various vibration coatings in their respective temperature ranges.

FIG. 8 is a second graph showing the Young's loss moduli of various vibration coatings in their respective temperature ranges.

FIG. 9 is a photograph of a micro jet turbine engine used for durability testing of the vibration damping coatings disclosed herein.

FIG. 10 is a photograph of a rotor, post-durability testing, that has one embodiment of a vibration damping coating plasma sprayed thereon.

### DETAILED DESCRIPTION

The following detailed description will illustrate the general principles of the invention, examples of which are additionally illustrated in the accompanying drawings. In the drawings, like reference numbers indicate identical or functionally similar elements.

Surface structures for turbine components are disclosed which provide vibration damping at elevated temperatures by absorbing vibration of the components and/or altering resonance frequencies of the components. The vibration damping increases fatigue lives of the components, for example, gas turbine components such as airfoils or rotor blades, compared to undamped components. Such surface structures may similarly be utilized to provide other benefits such as erosion resistance and thermal protection.

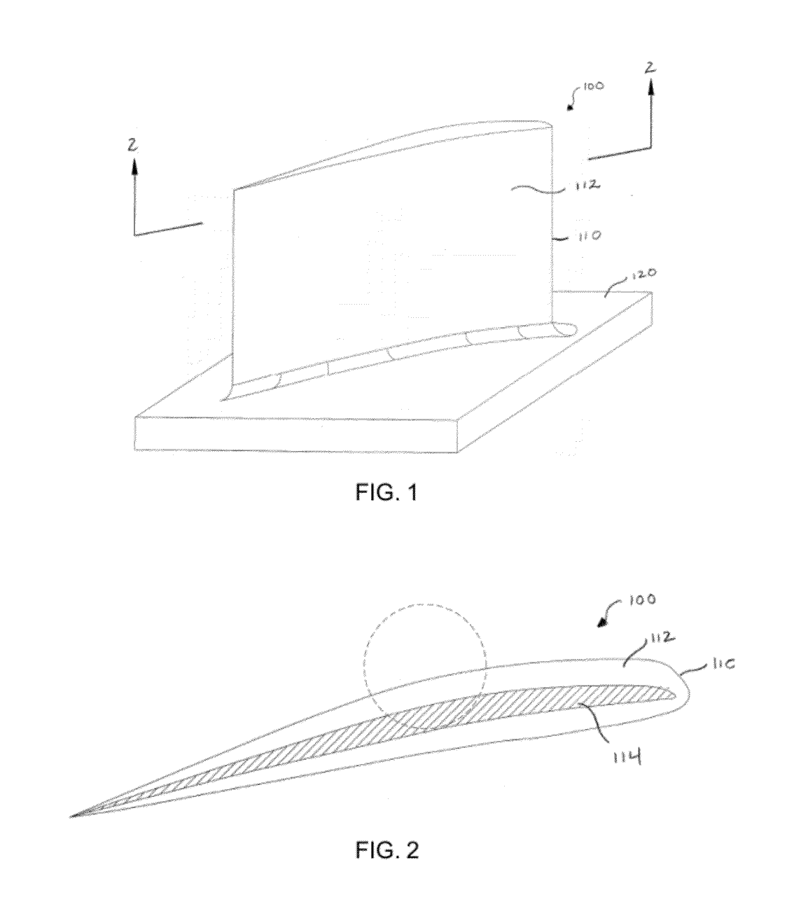

Referring to FIG. 1, a gas turbine component, generally designated 100, such as an airfoil 110 is shown that has enhanced vibration damping provided by a surface structure 112. Other gas turbine components such as a fan blade, a blisk blade, a compressor blade, a compressor vane, a turbine blade, or a turbine vane may also benefit from the enhanced vibration damping provided by the surface structure 112. The airfoil 110 may extend from a support structure 120, and may be diffusion bonded thereto, friction welded thereto, or machined out of the support structure 120. In one embodiment, the article having enhanced vibration damping is a rotor with integral blades. Although the present figures illustrate the enhanced vibration damping for a gas turbine component, the application of the surface structure 112 thereto is not limiting. The surface structure 112 may be applied to any component in need of enhanced vibration damping, in particular, components exposed to temperatures between about 700° F.-1500° F. Such temperatures may be experienced in other engines, for example, an automotive turbocharger. In one embodiment, the component is one that is located in a high temperature compressor section of a gas engine, such as a gas turbine engine.

Referring now to FIG. 2, the airfoil 110 includes a substrate 114 having the surface structure 112 applied thereto that provides the substrate 114 with vibration damping characteristics. Surface structure 112 may contain one or more surface layers with varying properties. Embodiments of the vibration damping surface structure 112 may utilize change in chemical, structural, and/or mechanical properties of at least one component of the surface structure 112 to provide the vibration damping characteristics at selected temperatures. In one embodiment, the surface structure 112 includes a layer applied thereto as a plasma spray coating that provides the vibration damping.

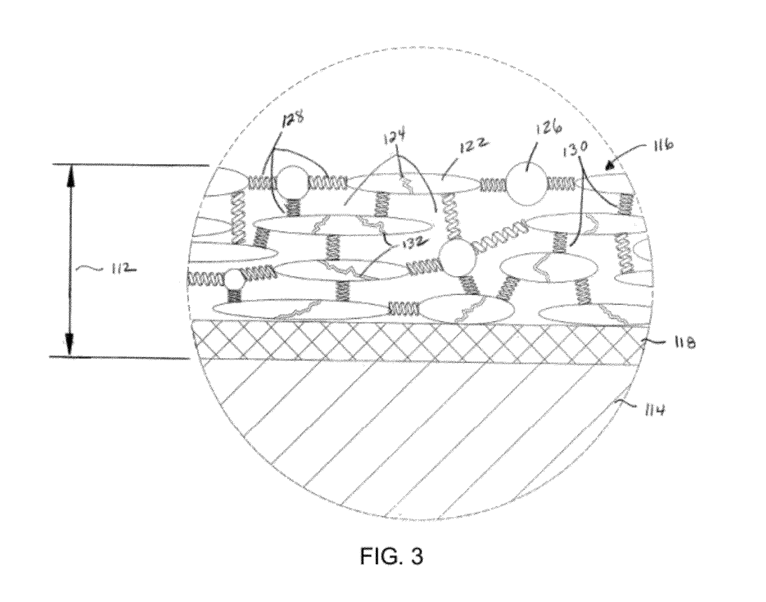

As shown in FIG. 3, one embodiment of the surface structure 112 may include a coating layer 116 to provide the vibration damping and a bondcoat 118. The bondcoat 118 is optional, but may be beneficial to promote adhesion between the substrate 114 and the coating layer 116. The coating layer 116 is a plasma spray coating having microstructures 122 of a hard material such as a ceramic, a metallic, or a cermet material with a viscoelastic glass frit material 126 distributed therebetween to interact with the microstructures 122 to provide vibration damping. The viscoelastic glass frit material 126 may penetrate micro-cracks and/or other surface anomalies in the hard coating material and significantly increase the damping behavior of the hard coating. The plasma spray coating is applied using thermal spray techniques known in the art. This thermal spray process includes rapid cooling of the coating material, which likely creates the micro-cracks and/or other surface anomalies that participate in the damping.

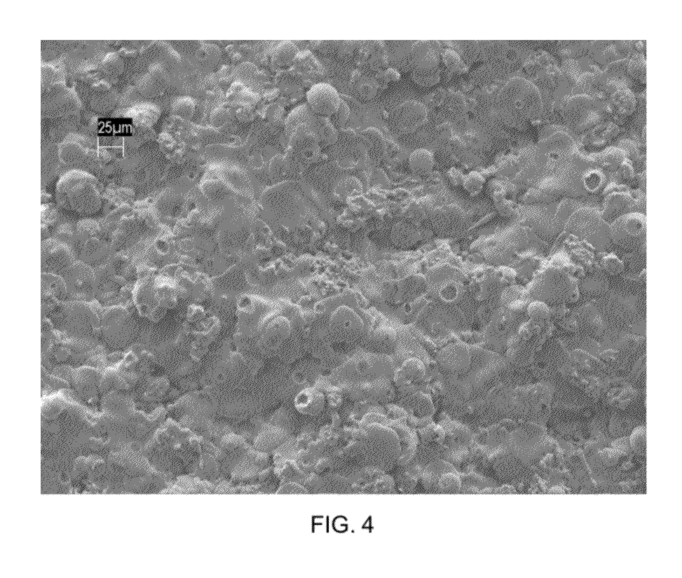

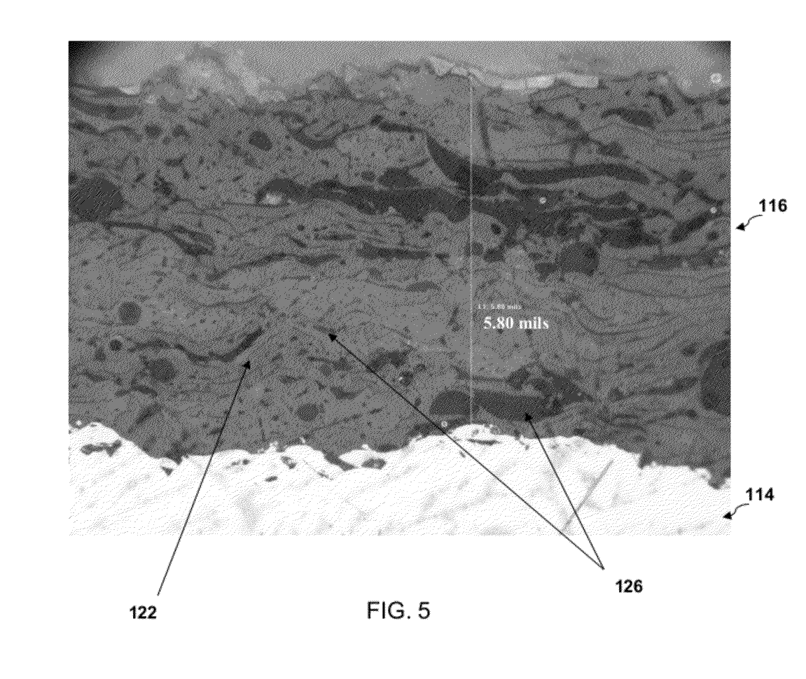

The microstructures deposited by the thermal spray techniques typically include a multitude of pancake-like lamellae called ‘splats’, formed by flattening of the liquid or melted droplets of a feedstock material. The feedstock powders may have sizes from micrometers to above 100 micrometers, thus the lamellae likely have a thickness in the micrometer range and lateral dimension from several to hundreds of micrometers. Between these lamellae, there are small voids, such as pores, cracks and regions of incomplete bonding. As a result of this unique structure, the deposits can have properties significantly different from bulk materials. These are generally mechanical properties, such as lower strength and modulus, higher strain tolerance, and lower thermal and electrical conductivity. Also, due to the rapid solidification, metastable phases can be present in the deposits. A SEM 25 μm scale top view image of a plasma spray coating layer 116 having zirconia microstructures and 10% of a viscoelastic glass frit material distributed therein is shown in FIG. 4 and a cross-sectional view through the coating layer 116 is shown in FIG. 5.

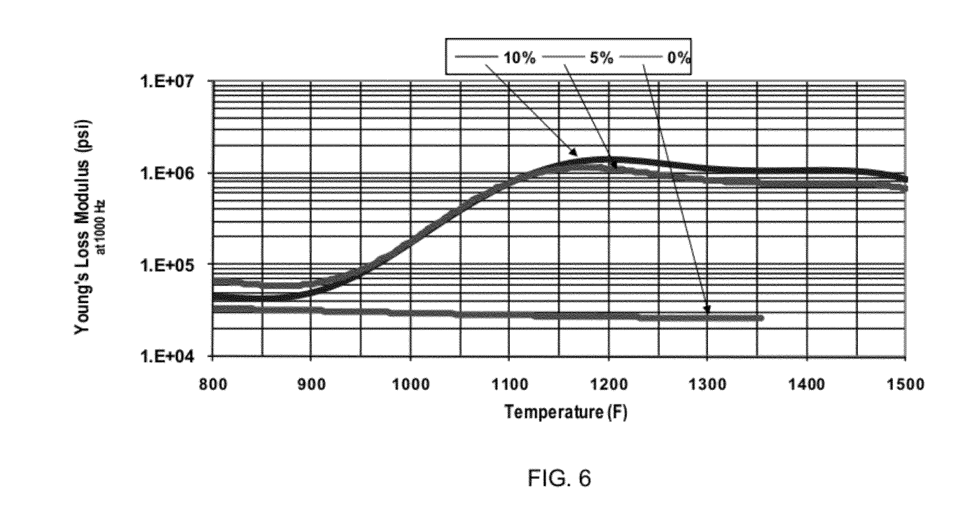

Referring to FIG. 3, present between the hard material, microstructures 122, and the viscoelastic glass frit material 126 are couplings 128 that represent the forces and/or interactions between these two components of the coating layer 116. Also present in the coating layer 116 are couplings 130 that represent the forces and/or interactions between microstructures 122. These couplings 128, 130 are not a material such as the hard material and viscoelastic glass frit, but instead represent a dynamic mechanical feature. While the couplings 128, 130 are shown in FIG. 3 as individual forces, the couplings may be branched or interrelated forces. As the viscoelastic glass frit material 126 experiences a change in its physical characteristics the couplings 128, 130 may change or be affected, typically improving damping as shown in FIGS. 6-8. One example physical characteristic that can change is the viscosity of the viscoelastic glass frit material 126 as it begins to soften as a result of increasing temperature.

The coating layer 116 is believed to reduce the vibration amplitude and modifies the vibration resonant response of the substrate by providing damping. In particular, Applicant believes that the viscoelastic glass frit material 126 dissipates mechanical strain energy in the form of thermal energy resulting in damping of the resonant vibrations and thereby prevents failures due to high cycle fatigue (HCF). Other factors that may affect the couplings 128, 130 and the overall damping of the substrate 114 may include, but are not limited to: the viscoelastic properties of the glass frit material 126; the density of the coating layer 116, the concentration of glass frit material 126 present in the coating layer 116; the material selected as the hard material that forms the microstructures 122; and the size of the microstructures 122 and/or glass frit material 126 present in the coating layer 116.

The coating layer 116 may be plasma sprayed onto the substrate 114 at a thickness of about 0.005 to about 0.01 inches thick. In one embodiment, the coating layer 116 is about 0.01 inches thick. In another embodiment, the coating layer 116 is about 0.0058 inches thick.

As mentioned above, the hard material may be a ceramic, metallic, or cermet material, but is not limited thereto. The hard material may be provided as a powder. The powder may have an average particle size of about 5 μm to about 120 μm, preferably about 10 μm to about 50 μm.

The ceramic may be, but is not limited to, an alumina, an alumina-titania blend, a chromia-alumina blend, a zirconia, a zirconia-silicate, a yttria stabilized zirconia, or combinations thereof. In one embodiment, the ceramic is a yttria-stabilized zirconia. The yttria-stabilized zirconia may contain about 3% to about 10% yttria, more preferably about 5% to about 8% yttria. In one embodiment, the yttria-stabilized zirconia is a 7% yttria-stabilized zirconia. In another embodiment, the yttria-stabilized zirconia is an 8% yttria-stabilized zirconia. When the coating layer 116 includes zirconia, the coating layer 116, in addition to providing damping characteristics to the article, can provide the article with a thermal barrier.

The hard material may be a metallic material, i.e., any metal or metal alloy powder. The metallic material may be, but is not limited to, an aluminum based powder, a cobalt based powder, a copper based powder, an iron based powder, a molybdenum based powder, and a nickel based powder. Various metal and metal alloy powders are available from Praxair Surface Technologies, Inc. Indianapolis, Ind.

The hard material may be a cermet. “Cermet” means a material comprising a metal or a metal alloy and a ceramic powder or a mixture of ceramic powders. Cermet is fabricated from the ceramic powder selected from a group of compounds represented and exemplified by the titanium-aluminum oxide system. Other systems, such as and including zirconium, hafnium, beryllium, vanadium oxides, nitrates, silicates or borides, etc., in combination with a metal, such as titanium, aluminum, magnesium, nickel, lithium, calcium, or their alloys are equally suitable for fabrication of cermets of the invention. In addition to these named systems, any other suitable alloy system meeting the general conditions for processing of the cermets may also be advantageously used to fabricate these cermets using the molten-metal-infiltration method and process and are intended to be within the scope of the invention. In one embodiment, the cermet may be a mixture of a ceramic, such as for example, aluminum oxide, zirconium oxide, hafnium oxide, beryllium oxide, vanadium oxide, boron carbide, aluminum nitride, zirconium nitride, hafnium nitride, vanadium nitride, aluminum boride, zirconium boride, hafnium boride, vanadium boride, aluminum silicate, zirconium silicate, hafnium silicate, vanadium silicate powders or their mixtures, in combination with a metal such as titanium, aluminum, magnesium, nickel, lithium, calcium, or other suitable metals, or their alloys, etc.

As used herein, the term “viscoelastic glass frit” refers to glass or porcelain enamel that starts to soften and exhibits viscoelastic behavior in a particular temperature range. In one embodiment, the temperature range of interest is about 700° F. to about 1500° F. In another embodiment, the temperature range of interest is about 900° F. to about 1100° F. In another embodiment, the temperature range of interest is about 1100° F. to about 1300° F.

To provide damping at temperatures between about 700° F. to about 1500° F., the glass frit should have a glass transition temperature (T_{g}) of at least about 700° F. or at least 900° F. In one embodiment, the glass transition temperature is between about 900° F. to about 1200° F. In one embodiment, the glass frit has an initial softening point of at least 700° F. or of at least 900° F. In another embodiment, the glass frit has an initial softening point of about 900° F. to about 1000° F. These softening points may be determined by placing the glass frit in an air furnace for 1 hour, removing the glass frit for visual examination for evidence of melting or softening, and replacing the glass frit in the air furnace, increasing the temperature of air furnace by 25 degrees and repeating the process until evidence of melting or softening is observed.

The glass frits may include, but is not limited to aluminum, silicon, barium, boron, fluorine, sodium, antimony, cobalt, lead, cadmium, lithium, vanadium, titanium, phosphorus, and combinations thereof. In one embodiment, the glass frit includes aluminum, silicon, barium, boron, fluorine, sodium, or combinations thereof. In another embodiment, the glass frit includes aluminum, barium, boron, fluorine, sodium. In yet another embodiment, the glass frit includes silicon, barium, boron, fluorine, sodium, and trace amounts of lithium, vanadium, titanium, phosphorus, or combinations thereof. In one embodiment, the glass frit includes about 20-30% by weight aluminum or about 90-95% by weight aluminum. The glass frit may also include one or both of about 45-60% by weight boron and about 1-20% by weight barium. Glass fits are commercially available, for example, from Pemco International. The glass frit is preferably a powder. The powder may have particles having an average particle size of about 5 μm to about 50 μm.

The hard material powder and the glass frit powder may be mixed together to create a powder mixture that is plasma sprayed onto substrate 114. The mixture may be blended by mechanical blending, sintering, or a combination thereof. In one embodiment, the mixture was blended by mechanical blending to provide a powder feedstock for the plasma spray apparatus. The glass frit, in particular the viscoelastic glass frit powder, may be about 15% or less by weight of the mixture. In one embodiment, the glass frit is about 10% or less by weight of the mixture. In another embodiment, the glass frit is about 5% or less by weight of the mixture.

The optional bondcoat 118 may be a metal or metal alloy layer applied to the substrate 114 to improve adhesion of the coating layer 116 to the substrate 114. Accordingly, the bondcoat is applied before depositing the coating layer 116. The metal or metal alloy may be a powder for thermal spray applications such that the bondcoat may be provided as a plasma spray coating. The bondcoat 118 may be applied at a thickness of about 0.002 to about 0.004 inches. In one embodiment, the bondcoat 118 is about 0.003 inches thick. The metal or metal alloy may be a powder, for example, but not limited to, an aluminum, cobalt, copper, iron, molybdenum, nickel metal or metal alloys. Such powders are available from Praxair Surface Technologies, Indianapolis, Ind. In one embodiment, the bondcoat is a NiCrAlY alloy.

### EXAMPLES

The Young's loss modulus was used to measure the effectiveness of the coating layer 116 at providing damping to the substrate 114. The damping from a coating is proportional to the Young's loss modulus multiplied by the thickness of the coating.

In the following examples, beams coated with surface structure 112 were tested to ascertain the influence strain amplitude has on its material properties. The testing of the surface structure 112, which included a layer having the plasma sprayed damping coating 116 with a dispersed viscoelastic glass-fit material therein and a bondcoat 118 coating both sides of a rectangular beam substrate of Hastelloy® X (composition: Ni 47%, Cr 22%, Fe 18%, Mo 9%, Co 1.5%, and less than 1% C, Mn, W, B, and Si). The rectangular beam was 0.0625 in thick, 0.75 inches wide and included a free section 8.5 inches long. The rectangular beam was then mounted on a large shaker with the free section inserted sufficiently far into a heating chamber as to assure a nearly uniform temperature distribution while isolating sensitive shaker components, Thereafter, the rectangular beam was excited as a cantilevered beam to measure the frequency response functions of the system and extract therefrom the system's resonant frequency and loss factors.

The surface structure 112 included a plasma spray bondcoat 118 of NiCrAlY adjacent to the outer surface of the substrate and as a plasma spray damping coating 116 adjacent to the bondcoat. The bondcoat 118 was present as a 3 mil layer and the damping coating 116 was present as a 10 mil layer for the examples, unless stated otherwise in the examples below.

Testing was conducted by obtaining frequency functions through excitation of the above test piece with an Unholtz-Dickie model SA15-560 shaker (rated at 600 pounds). The shaker was controlled using Vibration View or Unholtz-Dickie software and a feedback control system through an accelerometer located on the fixture near the root of the test piece. The test piece was clamped as a cantilevered beam using a support fixture mounted to the top of the shaker. The support fixture was made from a solid piece of Inconel® material and uses 1.5″ thick steel blocks to clamp the specimen in place.

A Polytec® single point laser vibrometer was used to take velocity measurements on the specimen with nominal influence on the response of the specimen. Measurement of velocities up to 10 m/s were possible. A reflective sticker of negligible mass and stiffness was attached to the specimen at the measurement point, chosen at a point well-removed from any node of the mode of interest, as determined from the displacement mode shapes of the cantilever beam.

### Example 1

Using the above equipment and test method, three test pieces each having a 3 mil bondcoat of NiCrAlY and a 10 mil damping coating were prepared. Test piece one had an 8% yttria-stabilized zirconia damping coating with no viscoelastic glass frit present. Test piece two had a damping coating containing an 8% yttria-stabilized zirconia with 5% by weight of a viscoelastic glass frit dispersed therein. Test piece three had a damping coating containing an 8% yttria-stabilized zirconia with 10% by weight of a viscoelastic glass frit dispersed therein. The viscoelastic glass frit (“Frit 4”) included 22-27% by weight Al, 10-20% by weight Ba, 45-50% by weight B, 10-20% by weight F, and 15-20% sodium.

From the frequency responses of the coated specimens and data on the coating thickness and densities at 1000 Hz over the temperature range of 800° F. to 1500° F. the Young's loss modulus was calculated for each test piece. The results are presented graphically in FIG. 6. FIG. 6 demonstrates that damping of the zirconium oxide (ZrO₂) “hard” damping coating is increased by a factor as high as thirty at temperature of 1000-1400° F. when just 5% by weight of the viscoelastic glass frit has been embedded in the coating. Even higher damping is achieved when 10% of the viscoelastic glass frit is used.

### Example 2

Using the above equipment and test method, three test pieces were prepared for testing for comparative analysis. The test piece of interest is the “Frit 4 in Zirconia” containing a 3 mil bondcoat of NiCrAlY and a 10 mil damping coating containing an 8% yttria-stabilized zirconia with 10% by weight of a viscoelastic glass frit dispersed therein. This test piece was compared to a “Lord LD-400” test piece (a room temperature damping material commonly used as a free layer coating) and an “APS 600 in Titania” test piece (a VEM infiltrated damping coating optimized for 200-300° F.).

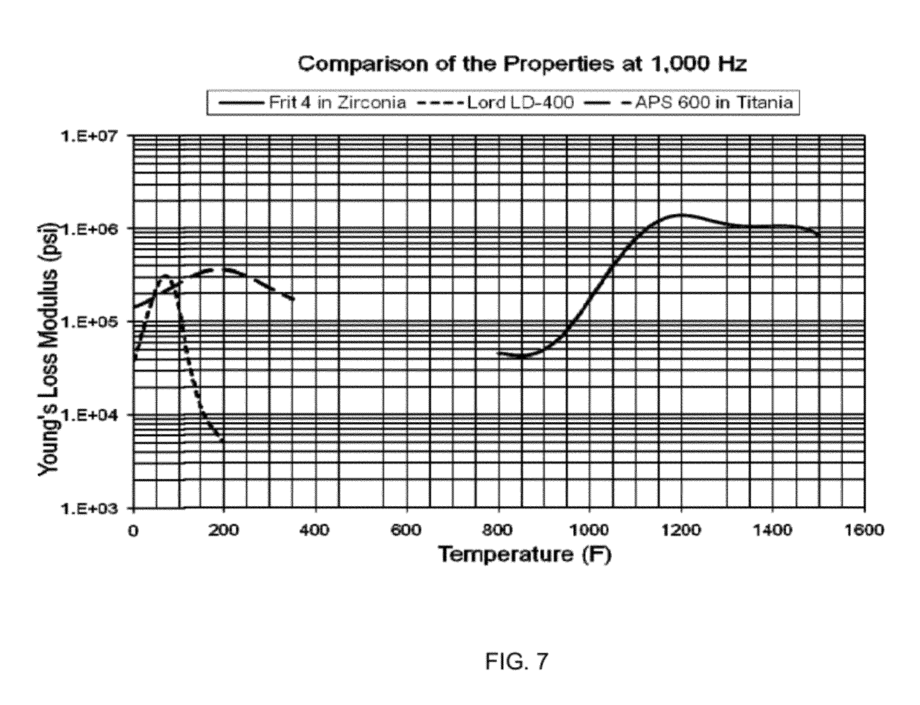

From the frequency responses of the coated specimens and data on the coating thickness and densities at 1000 Hz over the temperature range of about 0° F. to 1600° F., the Young's loss modulus was calculated for each test piece. The results are illustrated in FIG. 7. FIG. 7 reveals that the Young's loss modulus of the zirconium oxide (ZrO₂) “hard” damping coating embedded with the viscoelastic glass frit material, identified as Frit 4, has a higher Young's loss modulus in its optimum temperature range than the other materials in their optimum temperature ranges.

### Example 3

Using the above equipment and test method, four test pieces each having a 3 mil bondcoat of NiCrAlY and a 10 mil damping coating were prepared. Test piece one is the baseline having only an 8% yttria-stabilized zirconia damping coating. Test piece A had a damping coating containing an 8% yttria-stabilized zirconia with 10% by weight of Frit 4 dispersed therein. Test piece B had a damping coating containing an 8% yttria-stabilized zirconia with 10% by weight of a viscoelastic glass frit of 20-30% by weight Al, 50-60% by weight B, and 20-30% by weight Na dispersed therein. Test Piece C had a damping coating containing an 8% yttria-stabilized zirconia with 10% by weight of a viscoelastic glass frit of 90-95% by weight Al, 1-5% by weight Ba, and 1-5% by weight Sb dispersed therein.

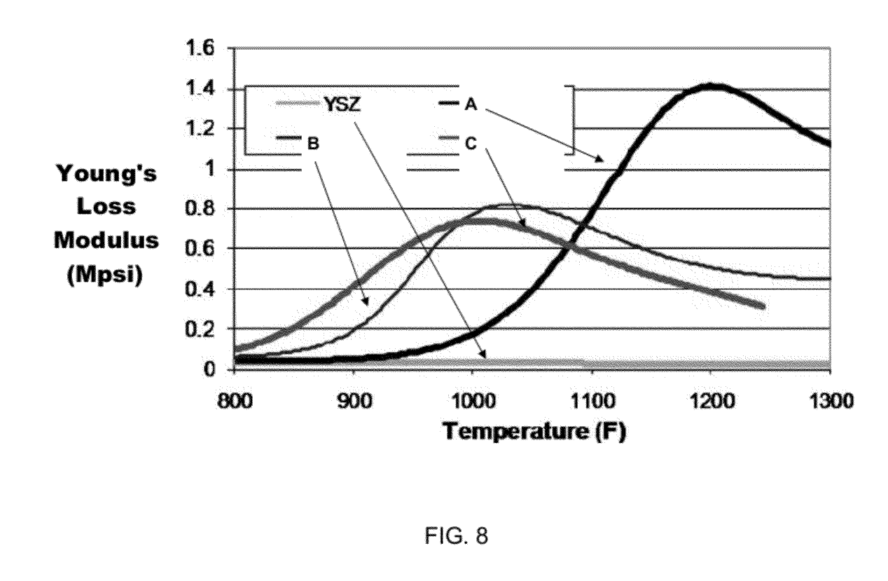

From the frequency responses of the coated specimens and data on the coating thickness and densities at 1000 Hz over the temperature range of 800° F. to 1500° F. the Young's loss modulus was calculated for each test piece. The results are presented graphically in FIG. 8. FIG. 8 demonstrates that damping of test pieces A-C are each effective in the temperature range of 800° F. to 1500° F. However, the zirconium oxide (ZrO₂) “hard” damping coating having Frit 4 provided the highest damping at the highest temperature; specifically test piece A had a Young's loss modulus of about 1.4 Mpsi at about 1200° F. Test piece B had a Young's loss modulus of about 0.8 Mpsi at about 1025° F. Test piece C had a Young's loss modulus of about 0.75 Mpsi at about 1000° F.

Accordingly, an article having a plasma sprayed coating material containing a plurality of ceramic, metallic, or cermet microstructures with a viscoelastic glass frit distributed therein to interact with the microstructures has a Young's loss modulus at 100 Hz greater than about 200 ksi between about 800° F. to about 1500° F., more preferably between about 900° F. to about 1300° F. In another embodiment, the article having such a plasma spray coating has a Young's loss modulus at 100 Hz greater than about 200 ksi between about 1000° F. to about 1500° F. In another embodiment, the article has a Young's loss modulus at 1000 Hz greater than about 600 ksi between about 800° F. to about 1500° F., more preferably between about 950° F. to about 1080° F. In another embodiment, the article has a Young's loss modulus at 1000 Hz greater than about 700 ksi between about 980° F. to about 1280° F. In another embodiment, the article has a Young's loss modulus at 1000 Hz greater than about 1000 ksi between about 1110° F. to about 1320° F.

### Example 4

### Durability Testing

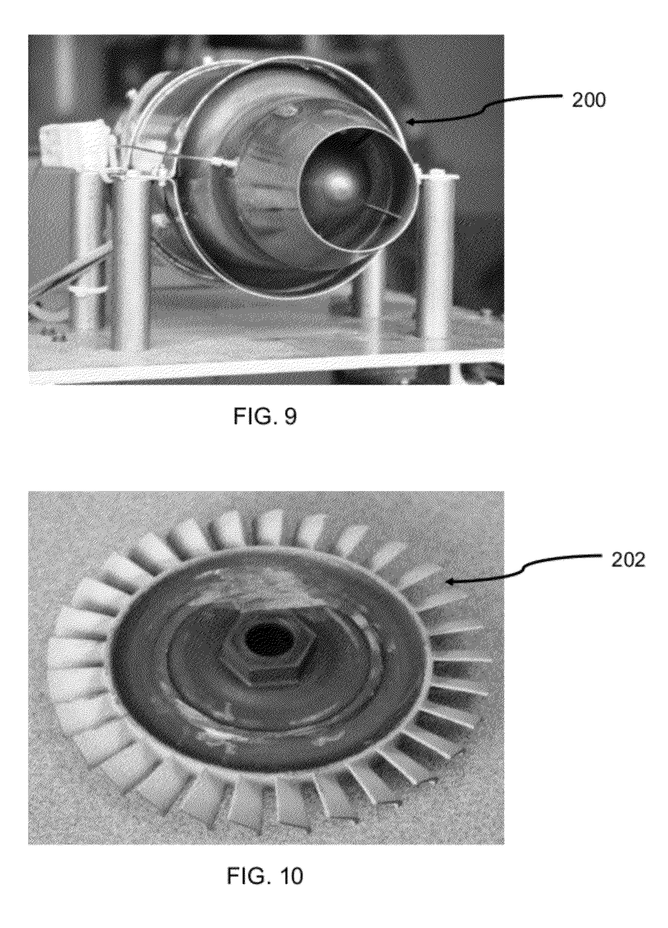

The durability of the plasma spray coatings disclosed herein were tested using a micro jet turbine engine 200, available from Aviation Micro Turbines USA, and shown in FIG. 9. A hot section rotor 202 from the micro jet turbine engine 200 was first plasma sprayed with a 2 mil layer of NiCrAlY bondcoat and then was plasma sprayed with an 8-10 mil layer of a damping coating containing an 8% yttria-stabilized zirconia and 5% by weight of Frit 4. The coating was lightly sanded to reduce the “as sprayed” coating surface roughness. The rotor 202 was returned to the micro jet turbine engine and operated at 97,000 RPM for 1 hour. The temperature at the exit of the engine was 1250° F. The coatings were also tested in a spin pit at 1200° F. and accelerations of up to 120,000 Gs with no indication of creep. High cycle (10⁶ cycles) step fatigue tests (A ration=1) were conducted at 1200° F. on Inconel 718 specimens with and without damping coatings showing no significant reduction in fatigue strength due to the presence of the coating.

After the test, the rotor 202 was removed and was inspected. A photograph of the rotor 202 is provided as FIG. 10. The coating survived the test and showed no evidence of spalling or cracking.

The embodiments of this invention shown in the drawing and described above are exemplary of numerous embodiments that may be made within the scope of the appended claims. It is contemplated that numerous other configurations of the vibration damping coating may be created taking advantage of the disclosed approach. In short, it is the applicant's intention that the scope of the patent issuing herefrom will be limited only by the scope of the appended claims.

What is claimed is:

1. A method of applying a vibration damping surface to an article, the method comprising:
providing a coating material comprising a ceramic, metallic or cermet material and a viscoelastic glass frit; and
plasma spraying the coating material onto the article, wherein the coating material forms a plurality of ceramic, metallic or cermet microstructures with the viscoelastic glass frit distributed to interact with the microstructures to provide vibration damping.

2. The method of claim 1 wherein the microstructures are generally pancake-like lamellae.

3. The method of claim 1 wherein the microstructures include voids, the voids being selected from the group consisting of microcracks, pores, regions of incomplete bonding, and combinations thereof.

4. The method of claim 1 wherein the viscoelastic glass frit provides vibration damping by converting vibrational energy in the article to thermal energy.

5. The method of claim 1 wherein the coating material is a mixture of the ceramic, metallic or cermet and the viscoelastic glass frit.

6. The method of claim 5 wherein the ceramic, metallic or cermet is a powder and the viscoelastic glass frit is a powder.

7. The method of claim 1 wherein the coating material includes about 15% by weight or less of the viscoelastic glass frit powder.

8. The method of claim 1 wherein the coating material includes about 10% by weight or less of the viscoelastic glass frit powder.

9. The method of claim 1 wherein the viscoelastic glass frit has an initial softening point of at least about 700° F.

10. The method of claim 9 wherein the viscoelastic glass frit has an initial softening point of at least about 900° F.

11. The method of claim 1 wherein the ceramic, metallic, or cermet includes zirconia.

12. The method of claim 11 wherein the ceramic, metallic, or cermet includes yttria-stabilized zirconia.

13. The method of claim 12 wherein the yttria-stabilized zirconia comprises about 3% to about 10% by weight yttria.

14. The method of claim 13 wherein the yttria-stabilized zirconia comprises about 5% to about 8% by weight yttria.

15. The method of claim 1 wherein the coating material includes about 10% by weight of the viscoelastic glass frit powder.

16. The method of claim 15 wherein the article having the plasma sprayed coating material thereon has a Young's loss modulus at 1000 Hertz of greater than about 200 ksi between 800° F. and 1500° F.

17. The method of claim 16 wherein the Young's loss modulus is greater than 600 ksi.

18. The method of claim 16 wherein the Young's loss modulus is greater than 700 ksi.

19. The method of claim 16 wherein the Young's loss modulus is greater than 1000 ksi.

20. The method of claim 15 wherein the article having the plasma sprayed coating material thereon has a Young's loss modulus at 1000 Hertz of greater than about 200 ksi between 900° F. and 1300° F.

21. The method of claim 15 wherein the article having the plasma sprayed coating material thereon has a Young's loss modulus at 1000 Hertz of greater than about 200 ksi between 1000° F. and 1500° F.

22. The method of claim 15 wherein the article having the plasma sprayed coating material thereon has a Young's loss modulus at 1000 Hertz of greater than about 600 ksi between 950° F. and 1080° F.

23. The method of claim 22 wherein the viscoelastic glass frit comprises 20-30% by weight Al, 50-60% by weight B, and 20-30% by weight Na or comprises 90-95% by weight Al, 1-5% by weight Ba, and 1-5% by weight Sb.

24. The method of claim 15 wherein the article having the plasma sprayed coating material thereon has a Young's loss modulus at 1000 Hertz of greater than about 700 ksi between 980° F. and 1280° F.

25. The method of claim 15 wherein the article having the plasma sprayed coating material thereon has a Young's loss modulus at 1000 Hertz of greater than about 1000 ksi between 1110° F. and 1320° F.

26. The method of claim 25 wherein the viscoelastic glass frit comprises 22-27% by weight Al, 10-20% by weight Ba, 45-50% by weight B, 10-20% by weight F, and 15-20% by weight Na.

27. The method of claim 1 wherein the article comprises a component of a gas turbine engine or of an automotive turbocharger.

28. The method of claim 24 wherein the component is positioned in a section of the gas turbine engine or the automotive turbocharger experiencing temperatures of about 800° F. to about 1500° F.

29. The method of claim 1 further comprising applying a bondcoat to the article before plasma spraying the coating material.

30. A plasma spray coating for damping vibrations comprising:
a ceramic-glass frit composite coating capable of reducing resonant vibrations in a substrate at temperatures between 800° F. to 1500° F.

31. The plasma spray coating of claim 30 wherein the composite is applied to the substrate and the substrate is a component of an engine exposed to said temperatures.

32. The plasma spray coating of claim 30 wherein the ceramic-glass frit composite coating includes microstructures of generally pancake-like lamellae with the glass frit distributed therein to interact with the microstructures to provide damping characteristics to the composite coating, and wherein the microstructures include voids, the voids being selected from the group consisting of microcracks, pores, regions of incomplete bonding, and combinations thereof.

33. The plasma spray coating of claim 30 wherein the composite coating includes about 15% or less of the viscoelastic glass frit powder.

34. The plasma spray coating of claim 30 wherein the glass frit is a viscoelastic glass frit having an initial softening point of at least about 700° F.

35. The plasma spray coating of claim 30 wherein the glass frit is a viscoelastic glass frit having an initial softening point of at least about 900° F.

36. The plasma spray coating of claim 34 wherein the glass frit comprises at least one of aluminum, boron, barium, antimony, sodium, fluorine.

37. The plasma spray coating of claim 36 wherein the glass frit comprises about 20-30% by weight aluminum or about 90-95% by weight aluminum.

38. The plasma spray coating of claim 37 wherein the glass frit further comprises about 45-60% by weight boron, about 1-20% by weight barium, or combinations thereof.

39. The plasma spray coating of claim 30 wherein the composite coating includes a yttria-stabilized zirconia.

40. The plasma spray coating of claim 30 wherein the yttria-stabilized zirconia comprises about 5% to about 8% yttria.

41. The plasma spray coating of claim 30 wherein the coating material includes about 10% by weight of the viscoelastic glass frit powder.

42. The plasma spray coating of claim 41 wherein the article having the plasma sprayed coating material thereon has a Young's loss modulus at 1000 Hertz of greater than about 200 ksi between 800° F. and 1500° F.

43. The plasma spray coating of claim 42 wherein the Young's loss modulus is greater than 600 ksi.

44. The plasma spray coating of claim 42 wherein the Young's loss modulus is greater than 700 ksi.

45. The plasma spray coating of claim 42 wherein the Young's loss modulus is greater than 1000 ksi.

46. The plasma spray coating of claim 41 wherein the article having the plasma sprayed coating material thereon has a Young's loss modulus at 1000 Hertz of greater than about 600 ksi between 950° F. and 1080° F.

47. The plasma spray coating of claim 41 wherein the article having the plasma sprayed coating material thereon has a Young's loss modulus at 1000 Hertz of greater than about 700 ksi between 980° F. and 1280° F.

48. The plasma spray coating of claim 41 wherein the article having the plasma sprayed coating material thereon has a Young's loss modulus at 1000 Hertz of greater than about 1000 ksi between 1110° F. and 1320° F.

49. The plasma spray coating of claim 30 wherein the composite coating is coating a surface of a substrate.
